(19) United States
(12) Patent Application Publication
(10) Pub. No.: US 2026/0249636 A1
(43) Pub. Date: Aug. 27, 2026

(54) Removable Book Edge Print

(71) Applicant: The Books Edge LLC, Murfreesboro, TN (US)

(72) Inventor: Whitney Morgan McGowan, Murfreesboro, TN (US)

(21) Appl. No.: 19/547,593

(22) Filed: Feb. 23, 2026

Related U.S. Application Data
(60) Provisional application No. 63/762,641, filed on Feb. 25, 2025.

(51) Int. Cl. B42D 3/08; B42D 3/18; B42D 9/00

(52) U.S. Cl. CPC B42D 3/08; B42D 3/18; B42D 9/007

(57) ABSTRACT

In the systems and methods herein, removable book edge prints are disclosed, which include: a single-sided removable book edge print containing a perpendicular flap; a single-sided removable book edge print containing multi-flaps; a three-sided removable book edge print containing sleeve panels; a three-sided removable book edge print containing a centered internal fin; a two-sided removable book edge print containing sleeve panels; a two-sided removable book edge print containing a centered internal fin; and a two-sided removable book edge print containing corner sleeve panels.

### CROSS-REFERENCE TO RELATED APPLICATIONS

This application claims priority to US Provisional Patent Application Serial No. 63/762,641 filed on February 25, 2024, which is hereby incorporated by reference in its entirety.

### FIELD OF INVENTION

The systems and methods herein are directed to articles of manufacture for displaying art and complementing literary works.

### BACKGROUND

The collection of special edition books and painted edges dates back to the 1600s and has recently become a popular trend in the last 3 years. The price for a commissioned custom painting on a book or book set ranges from several hundred to several thousand dollars. Offering a removable print that mimics the look of a painted edge allows book collectors to display artwork for their favorite books at a fraction of the cost and without permanently altering the original book’s page edges. There are options for stencils that allow individuals to paint their own designs as a DIY kit directly onto the page edge as well as artists who offer painted designs and companies that print directly onto the page edges with industrial printers. However, these artworks are not removable and permanently alter the book’s page edge.

What is needed is the systems and methods herein. The systems and methods herein are directed to an article of manufacture that: (1) provides a manufactured offering of a removable print that mimics the look of a painted edge; (2) allows book collectors to display artwork for their favorite books at a fraction of the cost and without permanently altering the original book’s page edges; and (3) fits the aspect ratio of the original book’s page edges.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader’s understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIGS. 1A, 1B, 1C, and 1D are depictions of a single-sided removable book edge print containing a perpendicular flap.

FIGS. 2A, 2B, 2C, and 2D are depictions of a single-sided removable book edge print containing multi-flaps.

FIGS. 3A, 3B, and 3C, are depictions of a three-sided removable book edge print containing sleeve panels.

FIGS. 4A, 4B, and 4C are depictions of a three-sided removable book edge print containing a centered internal fin.

FIGS. 5A, 5B, and 5C are depictions of a three-sided removable book edge print containing corner sleeve panels.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

The systems and methods herein are directed to removable book edge prints, wherein the removable book edge prints is: (D1) a single-sided removable book edge print containing a perpendicular flap; (D2) a single-sided removable book edge print containing multi-flaps; (D3) a three-sided removable book edge print containing sleeve panels; (D4) a three-sided removable book edge print containing a centered internal fin; (D5) a two-sided removable book edge print containing sleeve panels; (D6) a two-sided removable book edge print containing a centered internal fin; or (D7) a two-sided removable book edge print containing corner sleeve panels. D1, D2, D3, D4, D5, D6, and D7 are: affordable, nondestructive, removable, and interchangeable for displaying different artwork, when appended to a book. When appended to the book, D1, D2, D3, D4, D5, D6, and D7 do not alter or damage the pages of the book, in the way the paint or ink of the book does in the instance of painting or printing directly on the book.

In the systems and methods herein, the optimal construction material of D1, D2, D3, D4, D5, D6, and D7 is rigid card stock. These materials for constructing D1, D2, D3, D4, D5, D6, and D7 offer the physical structure needed to prevent the print from warping or curling. Alternatively, a lightweight plastic, thin wood or metal would work as well. The flap on the backside of D1, D2, D3, D4, D5, D6, and D7 works best as card stock paper, thereby offering textile friction between the pages of the book to hold the print in place. In the case of using a less porous structural material, such as metal or plastic, a light texture should be applied to the surface of the single flap of D1 and multi-flaps of D2, to ensure said flaps of D1 and D2 do not easily slide between the pages when said flaps of D1 and D2 are inserted into the book. The printed ink/dye/toner/paint on the face of D1, D2, D3, D4, D5, D6, and D7 only matters for the desired lifetime and quality of the image desired. The alternate designs for construction can include a top and bottom, and/or side flaps that would fit between the books outer cover and the pages. The material and assembly is less cost effective to produce with this process, but would achieve the same result in displaying the artwork. The perpendicular flap centered on the back of the image of D1 is a preferred method as the flap in D1 can fold flat and allow the print to be used as a bookmark, when the book is being read and not on display.

In the systems and methods herein, the backside flap of D1 can act as a stand, whereby D1 can be displayed as a frameless artwork on a flat surface, if desired, in addition to being displayed between the covers of a book. When the flap of D1 is folded flat, D1 can also serve as a bookmark. D1 can also be a “base” structure that supports interchanging the artwork displayed on the front face of D1.

In the systems and methods herein, the aspect ratio of the respective physical designs of D1, D2, D3, D4, D5, D6, and D7 can be customized to each individual book and cannot be interchanged with other books or even other editions of the same book, due to the variation in book height and thickness. D1, D2, D3, D4, D5, D6, and D7 work with hardcover and paperback books, by virtue of the cover not contributing to the surface tension used to hold the print in place with the primary flap design.

In the systems and methods herein, edge print artwork (i.e., the image/artwork shown) on the front face of a display surface (e.g., surface 101, surface 201, surface 301, surface 401, and surface 501) faces out from the edge print (e.g., D1, D2, D3, D4, and D7) placed on an edge of the stack of pages in a book. The edge print (e.g., D1, D2, D3, D4, D5, D6, and D7) is made of a rigid card stock or similar thin flat material that is capable of being printed on or having a printed image adhered to the front face of a display surface (e.g., surfaces 101, 201, 301, 401, and 501). A printed image can also be adhered on edges 305, 307, 405, 407, and 505.

In the systems and methods herein, the display surface of the edge prints (e.g., surface 101 of D1, surface 201 of D2, surface 301 of D3, surface 401 of D4, and surface of D7) each comprise an appendage that is attached perpendicularly to the backside of the display surface, wherein the appendage is a flap (e.g., flap 103 in D1), flaps (e.g., flaps 203 in D2), sleeves (e.g., sleeve panels 309 in D3 and corner sleeve panels 513 in D7), or fin (e.g., fin 411 in D4). The flap can be fin like piece that is located on the backside of the of the edge prints (e.g., surface 101 of D1, surface 201 of D2, surface 301 of D3, surface 401 of D4), which: (i) sticks out perpendicularly at a true 90 degree angle and (ii) provides the surface tension when placed between the book’s pages in order to hold the image on display surface of the book’s page edge. The flap does not exceed the width of the print when folded flat against the back surface of the print and does not exceed the height of the print. The flap can be positioned as a singular protrusion from the center of the print (e.g., flap 103 in D1) or as multiple flaps extending from the outside edges on the top and bottom and/or left and right sides of the print and should fit the book’s page height and width when the book is closed (e.g., flaps 203 in D2). The flap contains enough surface texture to prevent slipping between the closed pages.

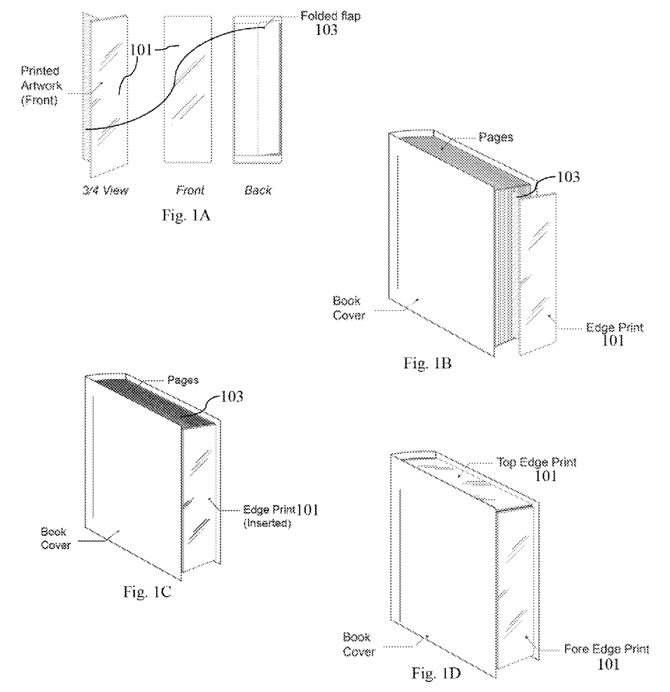

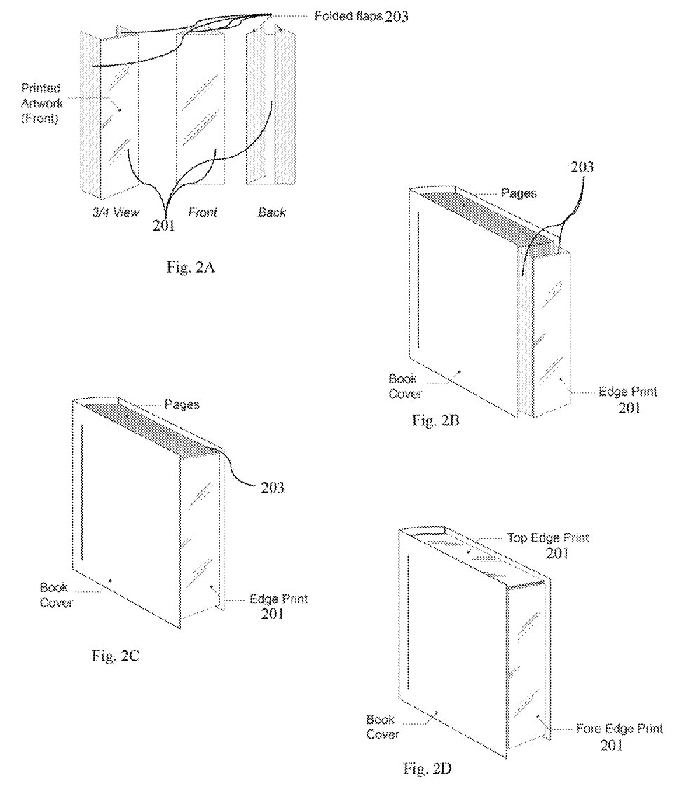

In the systems and methods herein, flap 103 or flaps 203 on the backside of the display surface is: (i) extended at a 90-degree angle from D1 or D2, respectively; and (ii) configured to be slipped between the pages of the book. The surface tension between the flap 103 or flaps 203, and the book’s pages when the book is closed, can provide enough friction to prevent D1 or D2 from sliding out and hold onto D1 or D2, such that display surface faces outward (e.g., surface 101 and surface 201), as depicted in FIGS. 1C and 2C, respectively. This mimics the appearance of a painted book edge and allows the owner of the print to display artwork in an affordable and nondestructive format on their book collection. D1, D2, D3, D4, D5, D6, and D7 can be displayed on the top, bottom and fore edge of their intended book or any book with the same aspect ratio for page edge dimensions.

In the systems and methods herein, the printed artwork can be placed on the front surface of display surface 101 of D1; and flap 103 of D1 is attached to the back surface of display surface 101, such that flap 103 adopts a perpendicular orientation or a folded orientation (see FIG. 1A). When flap 103 adopts a fully perpendicular orientation, D1 can be partially inserted into pages of a book (see FIG. 1B) or fully inserted into pages of a book (see FIG. 1C). In FIGS. 1A, 1B, and 1C, a single unit of D1 is inserted or partially inserted into the pages of a book. In FIG. 1D, two units of D1 are inserted into the pages of a book in the top edge and the fore edge.

In the systems and methods herein, the printed artwork can be placed on the front surface of display surface 201 of D2; and multi-flaps 203 of D2 (i.e., a hinge flap) are attached to the back surface of display surface 201 proximal to the left and right edges of display surface 201, such that multi-flaps 203 adopt a perpendicular orientation or a folded orientation (see FIG. 2A). When flap 203 adopts a fully perpendicular orientation, D2 can be partially inserted into pages of a book (see FIG. 2B) or fully inserted into pages of a book (see FIG. 2C). In FIGS. 2A, 2B, 2C, a single unit of D2 is inserted or partially inserted into the pages of a book. In FIG. 2D, two units of D2 are inserted into the pages of a book in the top edge and the fore edge.

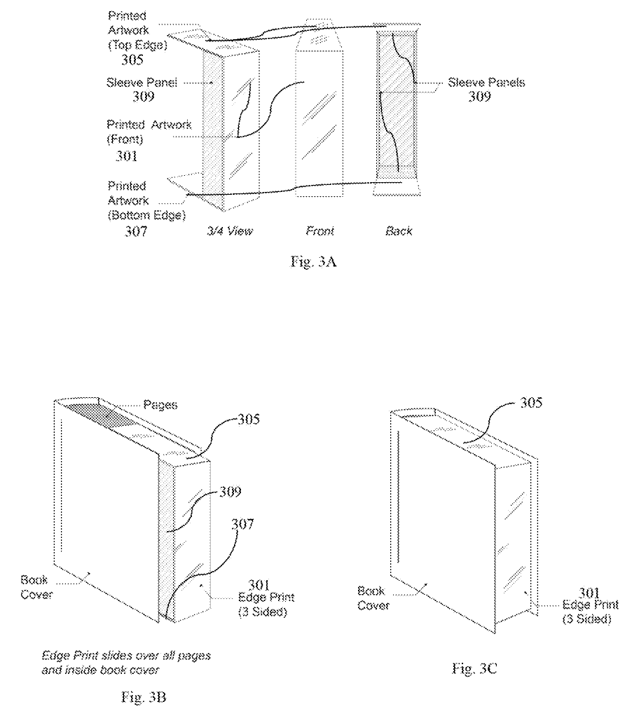

In the systems and methods herein, the printed artwork can be placed on: (i) the front surface of display surface 301, (ii) top edge 305, and (iii) bottom edge 307 of D3; and sleeve panels 309 of D3 are attached to the back surface of display surface 301 proximal to the left and right edges of display surface 301, such that panels 309 adopt a perpendicular orientation (see FIG. 3A). D3 can be partially inserted into pages of a book (see FIG. 3B) or fully inserted into pages of a book (see FIG. 3C), such that three edges (display surface 301, top edge 305, and bottom edge 307) can be placed over the pages of the book.

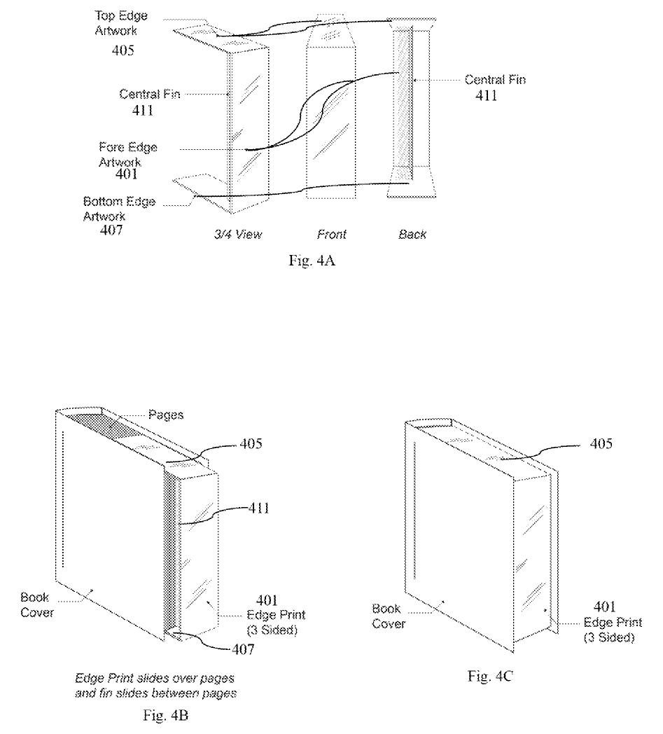

In the systems and methods herein, the printed artwork can be placed on: (i) the front surface of display surface 401, (ii) top edge 405, and (iii) bottom edge 407 of D4; and fin 411 of D4 is attached to the back surface of display surface 401 in the center position of display surface 301, such that fin 411 adopts a perpendicular orientation (see FIG. 4A). D4 can be partially inserted into pages of a book (see FIG. 4B) or fully inserted into pages of a book (see FIG. 4C), such that three edges (display surface 301, top edge 405, and bottom edge 407) can be placed over the pages of the book.

In the systems and methods herein, the printed artwork can be placed on the front surface of: (i) a display surface of D5 (front edge of D5) and (ii) a top edge/bottom edge of D5; and sleeve panels of D5 are attached to the back surface of display surface of D5 proximal to the left and right edges of display surface of D5, such that sleeve panels of D5 adopt a perpendicular orientation. D5 can be partially inserted into pages of a book or fully inserted into pages of a book , such that two edges (i.e., the display surface of D5 and the top edge/bottom edge of D5) can be placed over the pages of the book. The sleeve panels of D5 are similar to sleeve panels 309; and display surface of D5 is similar to surface 301. D5 and D3 are identical, except that D5 is a two-sided removable book edge print containing sleeve panels and D3 is a three-sided removable book edge print containing sleeve panels.

In the systems and methods herein, the printed artwork can be placed on the front surface of: (i) a display surface of D6 (front edge of D6) and (ii) top edge/bottom edge of D6; and a fin of D6 is attached to the back surface of display surface of D6 in the center position of display surface of D6, such that the fin of D6 adopts a perpendicular orientation. D6 can be partially inserted into pages of a book or fully inserted into pages of a book, such that two edges (i.e., the display surface of D6 and the top edge/bottom edge of D6) can be placed over the pages of the book. The fin of D6 is similar to fin 411; and the display surface of D6 is similar to surface 401. D6 and D4 are identical, except that D6 is a two-sided removable book edge print containing a centered internal fin and D4 is a three-sided removable book edge print containing a centered internal fin.

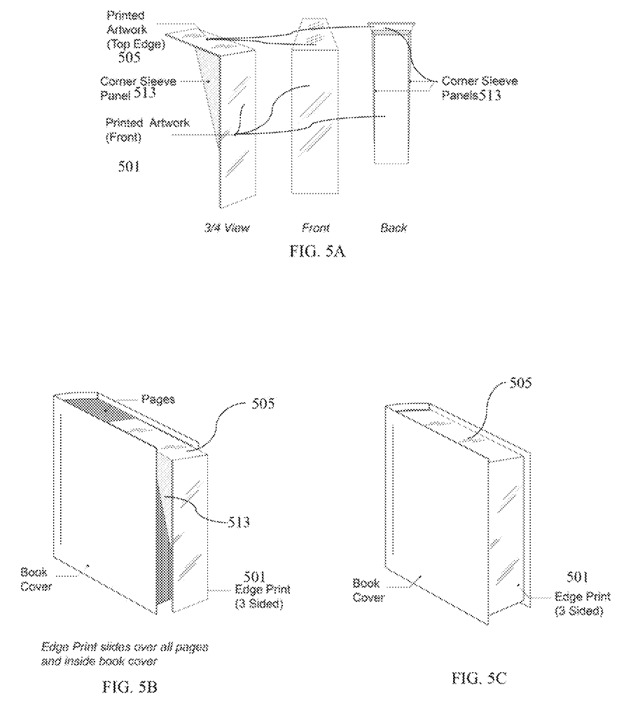

In the systems and methods herein, the printed artwork can be placed on: (i) the front surface of display surface 501 and/or (ii) top edge 505; and corner sleeve panels 513 are attached to the back surface of display surface 501 proximal to the left and right edges of display surface 501, such that corner sleeve panels 513 adopt a perpendicular orientation (see FIG. 5A). D7 can be partially inserted into pages of a book (see FIG. 5B) or fully inserted into pages of a book (see FIG. 5C), such that two edges (display surface 501 and top edge 505) can be placed over the pages of the book. D7 and D5 are identical, except that D7 has corner sleeve panels 513 and D5 has sleeve panels 309.

What is claimed is:

1. An assembly comprising:
a first display surface comprising a front side and a back side; and
an appendage operatively connected to the back side of the first display surface.

2. The assembly of claim 1, wherein the front side of the first display has artwork thereon.

3. The assembly of claim 1, wherein the appendage is hinged flaps, corner sleeve panels, or a fin.

4. The assembly of claim 1, further comprising a second display surface.

5. The assembly of claim 4, wherein the second display surface comprises a top side and a bottom side.

6. The assembly of claim 5, wherein the top side of the second display surface has artwork thereon.

7. The assembly of claim 3, wherein the fin is operatively connected to a center position of the back side of the first display surface.

8. The assembly of claim 3, wherein the hinged flaps are operatively connected proximal or at left and right most edges of the back side of the first display surface.

9. The assembly of claim 3, wherein the corner sleeve panels are operatively connected proximal or at left and right most edges of the back side of the first display surface.

10. The assembly of claim 4, wherein the second display surface is perpendicularly connected to the first display surface.

11. An assembly comprising:
a first display surface comprising a front side and a back side;
a second display surface comprising a top side and a bottom side; and
an appendage operatively connected to the back side of the first display surface.

12. The assembly of claim 11, wherein the front side of the first display has artwork thereon.

13. The assembly of claim 11, wherein the appendage is sleeve panels or a fin.

14. The assembly of claim 11, further comprising a third display surface.

15. The assembly of claim 14, wherein the third display surface comprises a top side and a bottom side.

16. The assembly of claim 11, wherein the top side of the second display surface has artwork thereon.

17. The assembly of claim 13, wherein the fin is operatively connected to a center position of the back side of the first display surface.

18. The assembly of claim 13, wherein the sleeve panels are operatively connected proximal or at left and right most edges of the back side of the first display surface.

19. The assembly of claim 11, wherein the first display surface is perpendicular to the second display surface.

20. The assembly of claim 14, wherein the third display surface is perpendicular to the first display surface.
